(19) United States
(12) Patent Application Publication
(10) Pub. No.: US 2002/0140402 A1
(43) Pub. Date: Oct. 3, 2002

(54) Voltage detecting circuit

(76) Inventor: Minoru Sudo, Chiba-shi (JP)

Correspondence Address: ADAMS & WILKS, 31st Floor, 50 Broadway, New York, NY, 10004, US

(21) Appl. No.: 10/079,164

(22) Filed: Feb. 20, 2002

(30) Foreign Application Priority Data
Mar. 30, 2001 (JP) 2001-100752

(51) Int. Cl. H02J 7/04

(52) U.S. Cl. 320/149

(57) ABSTRACT

A voltage detecting circuit controls the current consumption of the circuit so as to detect the voltage at a high speed with suppressing the consumption of a battery.

### BACKGROUND OF THE INVENTION

1. Field of the Invention

The present invention relates to a circuit for detecting a voltage in an integrated circuit contained in a portable device using a battery.

2. Description of the Related Art

As a voltage detecting circuit, there has been known a circuit shown in a circuit block diagram of FIG. 6. That is, terminals 10 and 11 are connected with an arbitrary terminal to be detected. In case of FIG. 6, since a battery 1 is connected to the terminals 11 and 10, a voltage across the battery 1 is detected. Voltage dividing resistors 13 and 14 are connected between the terminals 11 and 10. An input of a comparator 17 is connected with a node of those voltage dividing resistors 13 and 14 and a reference voltage 15. An output of the comparator 17 is connected with an output buffer circuit 16, and an output of the output buffer circuit 16 is connected with an output terminal 12.

The voltage is detected by comparing a voltage Va at the node of the voltage dividing resistors 13 and 14 with a voltage Vb of the reference voltage 15 by the comparator 17. That is, a voltage at which the comparator 17 is reversed is Va=Vb. In this example, Va is changed by the voltage across the battery 1 depending on a value of the voltage dividing resistors. Assuming that the resistance of the resistor 13 is R1, the resistance of the resistor 14 is R2 and the voltage across the battery 1 is V1, the detected voltage of the battery 1 is represented by the following expression (1) because of Va=R2/(R1+R2)×V1=Vb.

Detected voltage=(R1+R2)/R2×Vb (1)

That is, when the voltage across the battery 1 is higher than a value represented by the expression (1), the output of the comparator 17 becomes high level, whereas when the voltage across the battery 1 is lower than the value represented by the expression (1), the output of the comparator 17 becomes low level. In other words, it can be detected whether the voltage across the battery 1 is higher or lower than the detected voltage depending on whether the output of the comparator 17 is high level or low level.

In general, the voltage detecting circuit always operates so as to detect an arbitrary voltage. However, it is desirable that a current that is consumed due to the operation of the voltage detecting circuit is reduced as much as possible.

However, there was a problem in that when a current consumption is reduced in the conventional voltage detecting circuit, the response speed of the comparator in the voltage detecting circuit becomes low, with the result that a steep change in the voltage cannot be detected.

### SUMMARY OF THE INVENTION

The present invention has been made in order to solve the above-mentioned problem in association with the conventional circuit, and therefore an object of the present invention is to provide a voltage detecting circuit whose current consumption is reduced as much as possible to turn up a response speed of the voltage detecting circuit.

In order to achieve the object described above, according to the present invention, a voltage detecting circuit capable of changing over an operation speed is provided to thereby increase the current to turn up the operation speed when needed.

### BRIEF DESCRIPTION OF THE DRAWINGS

These and other objects and advantages of this invention will become more fully apparent from the following detailed description taken with the accompanying drawings in which:

FIG. 1 is a diagram showing a voltage detecting circuit in accordance with a first embodiment of the present invention;

FIG. 2 is a diagram showing a two-stage amplification comparator circuit;

FIG. 3 is a diagram showing a voltage detecting circuit in accordance with a second embodiment of the present invention;

FIGS. 4A to 4C are graphs illustrating an operation of the voltage detecting circuit in accordance with the second embodiment of the present invention;

FIGS. 5A to 5C are graphs illustrating an operation of the voltage detecting circuit in accordance with the second embodiment of the present invention; and

FIG. 6 is a block diagram showing a conventional low-voltage detecting circuit.

### DETAILED DESCRIPTION OF THE PREFERRED EMBODIMENTS

Hereinafter, a description will be given in more detail of preferred embodiments of the present invention with reference to the accompanying drawings.

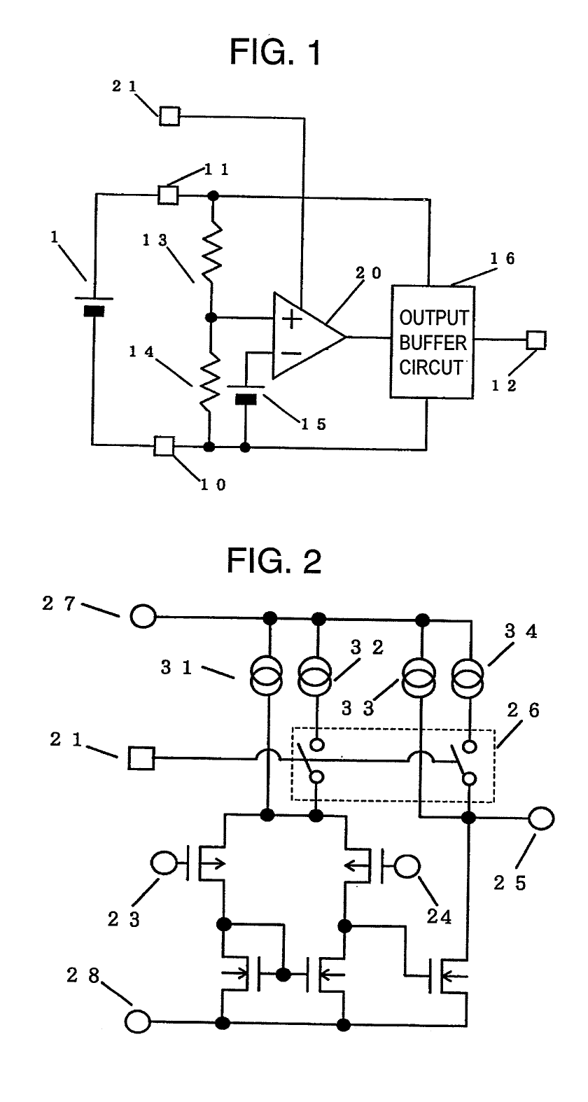

FIG. 1 is a diagram showing a voltage detecting circuit in accordance with a first embodiment of the present invention. FIG. 1 is different from FIG. 6 in that the comparator 17 is replaced with a comparator 20 that is connected with a terminal 21. The basic voltage detecting operation is identical with that in the conventional circuit.

The current consumption of the comparator 20 is changed in accordance with a voltage across the terminal 21 connected to the comparator 20.

An example of the comparator 20 is shown in FIG. 2. FIG. 2 shows an example of a two-stage amplification comparator. Nodes 24 and 23 are a plus input terminal and a minus input terminal of the comparator 20, and a node 25 is an output terminal of the comparator 20. Four constant current sources 31 to 34 exist in the comparator 20, and the constant current sources 31 and 33 are used to always operate the comparator 20 at a low speed. The constant current sources 32 and 34 are connected with a switch circuit 26 the on/off operation of which is controlled in accordance with a signal from an external terminal 21.

It is assumed that the switch circuit 26 turns on when a voltage at the terminal 21 is high (hereinafter referred to as “H”), and turns off when the voltage at the terminal 21 is low (hereinafter referred to as “L”). In the case where, as the voltage detecting circuit, greater importance is given to the current consumption than the operation speed, the voltage at the terminal 21 is set to “L”, and the current consumption of the circuit is reduced. Conversely, in the case where, as the voltage detecting circuit, greater importance is given to the operation speed than the current consumption, the voltage at the terminal 21 is set to “H”, and the current consumption of the circuit is increased.

For example, in FIG. 1, when a load is connected to the battery 1 and power consumption of the load is heavy, because a voltage drop of the battery 1 is also steep, the voltage at the terminal 21 is set to “H”, and the operation speed of the voltage detecting circuit is turned up. Conversely, when the power consumption of the load connected to the battery 1 is small, because the voltage drop of the battery 1 is also slow, the voltage at the terminal 21 is set to “L”, and the power consumption is reduced without increasing the speed of the voltage detecting circuit.

If a hysteresis function is added to the voltage detecting circuit of the first embodiment, the operation of the voltage detecting circuit is more stabilized.

(Second Embodiment)

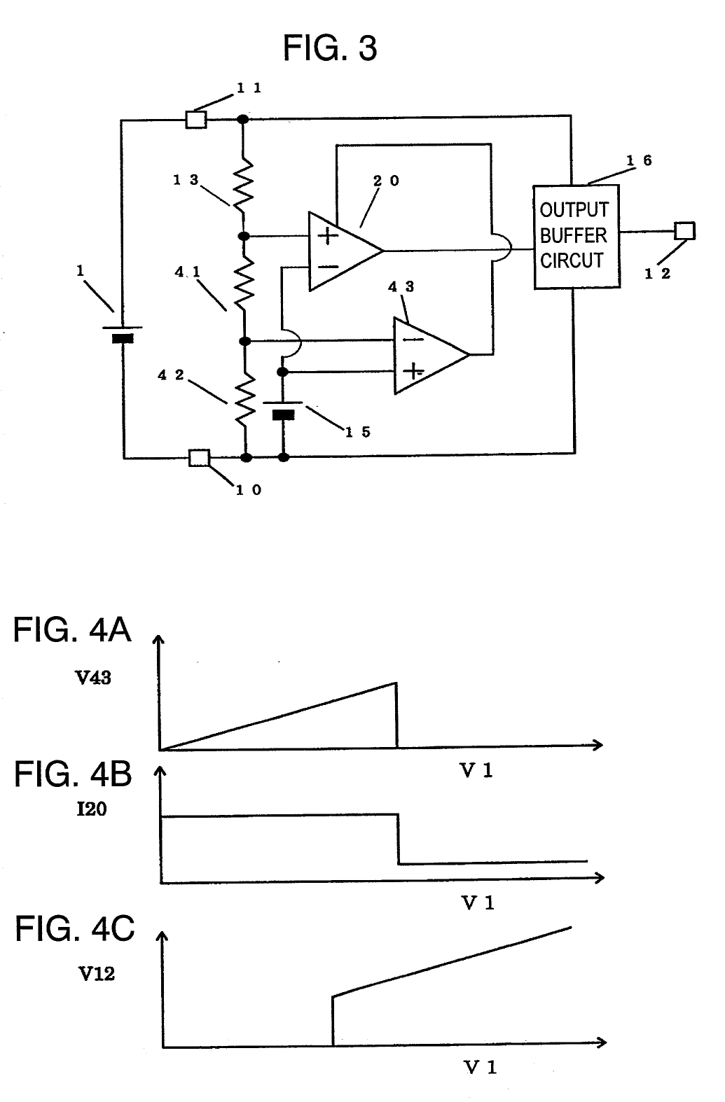

FIG. 3 is a diagram showing a voltage detecting circuit in accordance with a second embodiment of the present invention. The voltage detecting circuit shown in FIG. 3 is different from that in FIG. 1 in that the voltage dividing resistor 14 is replaced with voltage dividing resistors 41 and 42, and a comparator 43 is added so that a current value of the comparator 20 is controlled in accordance with an output of the comparator 43. Therefore, the terminal 21 shown in FIG. 1 is functionally replaced with the output of the comparator 43. Assuming that the values of the resistors 41 and 42 are R3 and R4, respectively, in order to obtain the same detected voltage as that in FIG. 1, R3+R4=R2 is satisfied in accordance with the expression (1). Also, a voltage at which the output of the comparator 43 is reversed is represented by the following expression (2) as in the expression (1).

Reverse Voltage=(R1+R3+R4)/R4×Vb (2)

That is, the output of the comparator 43 is always reversed at a voltage higher than the detected voltage.

FIGS. 4A, 4B and 4C show an output V43 of the comparator 43, a current I20 of the comparator 20 and an output voltage illustrating an operation of V12 of the voltage detecting circuit, respectively, with abscissa axes representing the voltage V1 of the battery 1.

In FIG. 4A, a voltage at which the voltage V43 changes from “H” to “L” is a voltage represented by the expression (2). When the voltage is lower than the voltage represented by the expression (2), the current consumption of the comparator 20 is increased. That is, the current of the comparator is increased immediately before the voltage shown in FIG. 4C is detected, to turn up the operation speed of the voltage detecting circuit.

With the above operation, when the voltage across the battery 1 is sufficiently high, the current in the voltage detecting circuit is reduced, and when the voltage across the battery 1 approaches the detected voltage of the voltage detecting circuit, the current consumption of the circuit is increased, thereby being capable of detecting the voltage drop at a high speed.

Subsequently, a case in which the hysteresis function exists in the comparator 20 will be described.

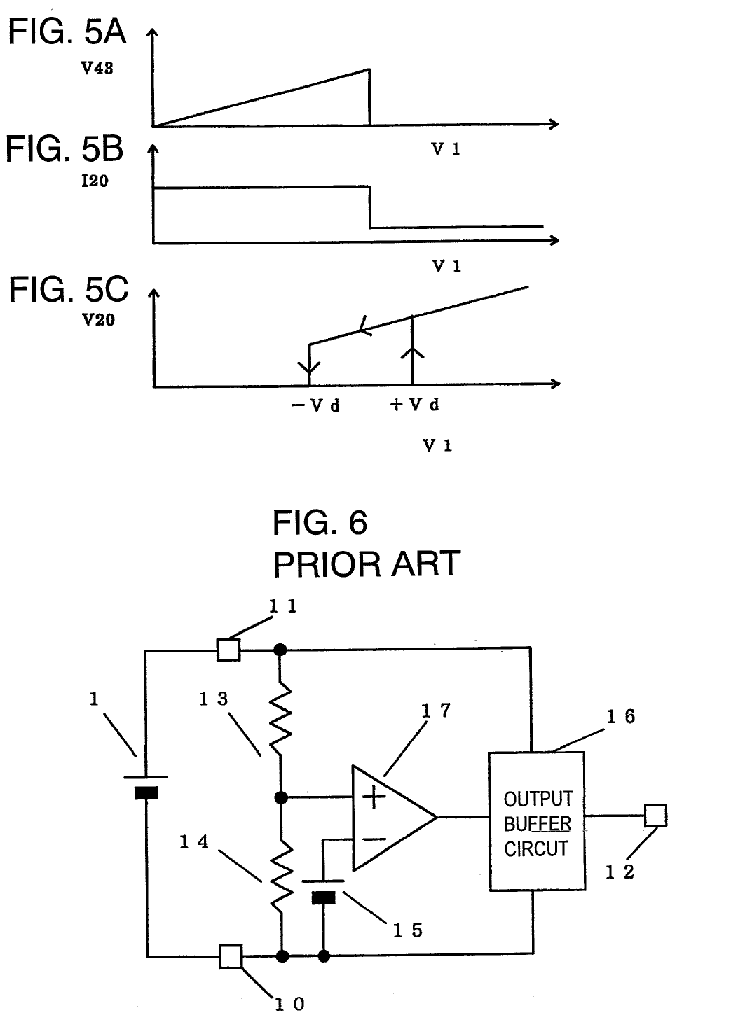

FIGS. 5A, 5B and 5C show an output V43 of the comparator 43 shown in FIG. 3, a current I20 of the comparator 20 shown in FIG. 3, and an output voltage V20 of the comparator 20 shown in FIG. 3, respectively, with abscissa axes representing the voltage V1 of the battery 1.

As shown in FIGS. 5A to 5C, the comparator 20 has a hysteresis function, and the detected voltage of the battery when the voltage across the battery 1 is increased from a lower voltage to a higher voltage is set to +Vd, whereas the detected voltage of the battery when the voltage across the battery 1 is decreased from the higher voltage to the lower voltage is set to −Vd. In this case, the hysteresis function is added to the comparator 20 shown in FIG. 3 so as to establish the relationship represented by the following expression (3).

+vd>−Vd (3)

The output of the comparator 43 is reversed between +Vd and −Vd shown in the expression (3).

The on/off function is added to the comparators 20 and 43 shown in FIG. 3, respectively, and when the power turns on, both of the comparators 20 and 43 are turned on, and thereafter when the voltage V1 across the battery 1 becomes equal to or more than +Vd of the comparator 20, the comparator 20 is made to turn off. Then, when the output of the comparator 43 changes from “H” to “L”, the comparator 20 is made to turn on, thereby being capable of further reducing the current consumption.

In the above-mentioned embodiments, the current value of the voltage detecting circuit changes over at two stages, but the current value of the voltage detecting circuit can change over at three or more stages.

As described above, the current value of the voltage detecting circuit is controlled so as to optimize the response speed and the current consumption of the voltage detecting circuit, thereby being capable of lengthening the operation time of a portable device using a battery.

As was described above, according to the voltage detecting circuit of the present invention, since the current increases and the response speed turns up only when the battery voltage is detected as occasion demands, there arises such an effect that the operation time of the portable device using the battery can be lengthened with the suppression of the unnecessary power consumption.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A voltage detecting circuit for detecting a voltage value of an arbitrary terminal, comprising a function for changing over the operation current of the voltage detecting circuit at least at two stages in accordance with an external signal.

2. A voltage detecting circuit, comprising:
a first voltage detecting circuit that detects a voltage value of an arbitrary terminal; and
a second voltage detecting circuit that detects the voltage value of said arbitrary terminal;
wherein a detected voltage value of said first voltage detecting circuit is lower than a detected voltage value of said second voltage detecting circuit, and when said second voltage detecting circuit detects the voltage value, a circuit current of said first voltage detecting circuit is increased.

3. A voltage detecting circuit comprising:
a divider having pair of resistors connect in series,
a comparator having a positive input terminal connected to a center of the divider, a negative input terminal connected to a reference voltage circuit and an input terminal connected to an outer terminal which control on and off of the comparator,
a buffer circuit connected to an output of the comparator.

4. A voltage detecting circuit comprising:
a divider having a first resistor, a second resistor and a third resistor connected in series,
a first comparator having an negative input terminal connected between the second resistor and the third resistor and a positive input terminal connected to a reference voltage circuit,
a second comparator having a positive input terminal connected between the first resistor and the second resistor, a negative input terminal connected to the reference voltage circuit and an input terminal connected to an output of the first comparator to switch on and off the second comparator,
a buffer circuit connected to an output of the second comparator.
